(19) United States
(12) Patent Application Publication
(10) Pub. No.: US 2010/0084977 A1
(43) Pub. Date: Apr. 8, 2010

(54) COLD CATHODE TUBE LAMP

(75) Inventor: Kenichi Iwamoto, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/524,730

(22) PCT Filed: Jan. 24, 2008
(86) PCT No.: PCT/JP2008/050956

§ 371 Date: Jul. 28, 2009

(30) Foreign Application Priority Data
Jan. 29, 2007 (JP) 2007-017537

(51) Int. Cl. H01J 61/56

(52) U.S. Cl. 315/59

(57) ABSTRACT

Disclosed is a cold cathode lamp composed of discharge tube having a glass tube and an internal electrode, and a ballast capacitor integrally mounted to the discharge tube. The ballast capacitor is composed of a first electrode formed on the outer surface of the discharge tube, a dielectric layer covering the first electrode, and a second electrode formed on the dielectric layer. The internal electrode and the first electrode are electrically connected with each other. At least one of the internal electrode and the first electrode has a portion exposed to the outside. The capacitance of the ballast capacitor can be measured by connecting the exposed portion and the second electrode to a measuring device. Consequently, variations in capacitance of the ballast capacitor, which cause variations in luminance of the cold cathode lamp, can be easily examined.

### BACKGROUND OF THE INVENTION

1. Field of the Invention

The present invention relates to a cold cathode tube lamp. In particular, the present invention relates to a cold cathode tube lamp that is provided with a ballast capacitor.

2. Description of the Related Art

Conventionally, cold cathode tube lamps are used as light sources for various devices. For example, conventionally, there are known cold cathode tube lamps that can be used as light sources (backlights) for liquid crystal display devices.

Conventional cold cathode tube lamps are, in terms of an equivalent circuit, a resistor whose resistance decreases nonlinearly as current increases, and have a nonlinear negative impedance characteristic like the V-I characteristic shown in FIG. 6. Thus, when an attempt is made to drive a plurality of cold cathode tube lamps connected in parallel, there arises the following inconvenience. Specifically, when an attempt is made to drive a plurality of cold cathode tube lamps connected in parallel, after the voltage across one predetermined cold cathode tube lamp reaches the withstand voltage (the voltage that causes insulation breakdown), the voltage across that one predetermined cold cathode tube lamp decreases due to the nonlinear negative impedance characteristic. Here, the voltage across the other cold cathode tube lamps is equal to the voltage across the one predetermined cold cathode tube lamp. Thus the voltage across the other cold cathode tube lamps does not reach the withstand voltage. This makes it difficult to light all of the cold cathode tube lamps.

To solve the inconvenience just described, one way is to connect separate inverter power supplies one to each of the plurality of cold cathode tube lamps. This, however, leads to inconveniences such as increased sizes of backlights.

Thus, a cold cathode tube lamp having a ballast capacitor connected to a discharge tube is conventionally proposed (for example, see JP-A-10-177170 Publication). According to JP-A-10-177170 Publication just mentioned, the equivalent circuit has a capacitor connected to a resistor whose resistance decreases nonlinearly as current increases, and thus has a nonlinear positive impedance characteristic like the V-I characteristic shown in FIG. 7. Thus, according to JP-A-10-177170 Publication mentioned above, when a plurality of cold cathode tube lamps connected in parallel are driven, all of the cold cathode tube lamps can be lit. Note that according to JP-A-10-177170 Publication, a ballast capacitor is housed inside an insulating rubber bush, and the insulating rubber bush is fitted to an end part of a discharge tube.

The cold cathode tube lamp according to JP-A-10-177170 Publication, however, has the following disadvantages. Since the ballast capacitor connected to the discharge tube is housed inside the insulating rubber bush, it is difficult to measure the amount of capacitance directly by connecting a measuring device to the ballast capacitor. That is, in the cold cathode tube lamp according to JP-A-10-177170 Publication, it is difficult to accurately grasp variations in the capacitance value of the ballast capacitor. As a result, due to the variations in the capacitance value of the ballast capacitor, the brightness of the cold cathode tube lamp varies disadvantageously.

### SUMMARY OF THE INVENTION

The present invention is devised to solve the above problems. An object of the invention is to provide a cold cathode tube lamp that has a ballast capacitor fitted to a discharge tube and yet can prevent variations in brightness.

To achieve the above object, according to a first aspect of the present invention, a cold cathode tube lamp is provided with a discharge tube that has an internal electrode, and a ballast capacitor fitted integrally with the discharge tube. The ballast capacitor is composed of a first electrode directly formed on an outer surface of the discharge tube, a dielectric layer so formed as to cover the first electrode, and a second electrode formed on the dielectric layer. The internal electrode of the discharge tube and the first electrode of the ballast capacitor are electrically connected with each other so as to have an equal potential. At least one of the internal electrode of the discharge tube and the first electrode of the ballast capacitor has a part exposed to outside to allow connection to a measuring device.

In the cold cathode tube lamp according to the first aspect, as described above, the ballast capacitor is composed of the first electrode directly formed on the outer surface of the discharge tube, the dielectric layer so formed as to cover the first electrode, and the second electrode formed on the dielectric layer. This makes it possible, without housing the ballast capacitor in a housing member or the like, to fit the ballast capacitor to the discharge tube integrally. In this case, when the internal electrode of the discharge tube has a part exposed to outside, it possible, since the internal electrode of the discharge tube and the first electrode of the ballast capacitor are electrically connected with each other so as to have an equal potential, to measure the capacitance value of the ballast capacitor by connecting a measuring device to the internal electrode of the discharge tube and to the second electrode of the ballast capacitor. On the other hand, when the first electrode of the ballast capacitor has a part exposed to outside, it is possible to measure the capacitance value of the ballast capacitor by connecting the measuring device to the first electrode and to the second electrode of the ballast capacitor. In this way, it is possible to accurately grasp variations in the capacitance value of the ballast capacitor. As a result, in the cold cathode tube lamp that has the ballast capacitor fitted to the discharge tube, it is possible to prevent an inconvenience in which, due to the variations in the capacitance value of the ballast capacitor, the brightness of the cold cathode tube lamp varies.

In the cold cathode tube lamp according to the above-described first aspect, preferably, the internal electrode of the discharge tube has a lead terminal portion connected electrically to the first electrode of the ballast capacitor; at least part of the lead terminal portion of the internal electrode of the discharge tube is exposed to outside. With this configuration, it is possible to expose to outside at least part of the internal electrode of the discharge tube easily.

In this case, preferably, at least part of the lead terminal portion of the internal electrode of the discharge tube penetrates the ballast capacitor and projects outward. With this configuration, it is possible, while electrically connecting the lead terminal portion of the internal electrode of the discharge tube to the first electrode of the ballast capacitor, to expose to outside at least part of the lead terminal portion easily.

In the cold cathode tube lamp according to the above-described first aspect, preferably, in the dielectric layer of the ballast capacitor, an open part is formed to exposed to outside at least part of the first electrode of the ballast capacitor. With this configuration, it possible to easily expose to outside at least part of the first electrode of the ballast capacitor through the open part formed in the dielectric layer of the ballast capacitor.

In the cold cathode tube lamp according to the above-described first aspect, preferably, an insulating cap is further provided for covering an exposed-to-outside part of at least one of the internal electrode of the discharge tube and the first electrode of the ballast capacitor. With this configuration, it is possible to insulate the exposed-to-outside part of at least one of the internal electrode of the discharge tube and the first electrode of the ballast capacitor when no measurement with a measuring device is performed.

As described above, according to the present invention, it is possible to obtain a cold cathode tube lamp that has a ballast capacitor fitted to a discharge tube and yet can prevent variations in brightness.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 A sectional view schematically showing the structure of a cold cathode tube lamp according to a first preferred embodiment of the present invention.

FIG. 2 A diagram showing the cold cathode tube lamp according to the first preferred embodiment shown in FIG. 1 in a state having a measuring device connected thereto.

FIG. 3 A diagram showing the cold cathode tube lamp according to the first preferred embodiment shown in FIG. 1 in a state having a measuring device connected thereto.

FIG. 4 A sectional view schematically showing the structure of a cold cathode tube lamp according to a second preferred embodiment of the present invention.

FIG. 5 A diagram showing the cold cathode tube lamp according to the second preferred embodiment shown in FIG. 4 in a state having a measuring device connected thereto.

FIG. 6 A diagram illustrating a characteristic of a cold cathode tube lamp.

FIG. 7 A diagram illustrating a characteristic of a cold cathode tube lamp that has a ballast capacitor connected to a discharge tube.

### DETAILED DESCRIPTION OF THE PREFERRED EMBODIMENT

### First Preferred Embodiment

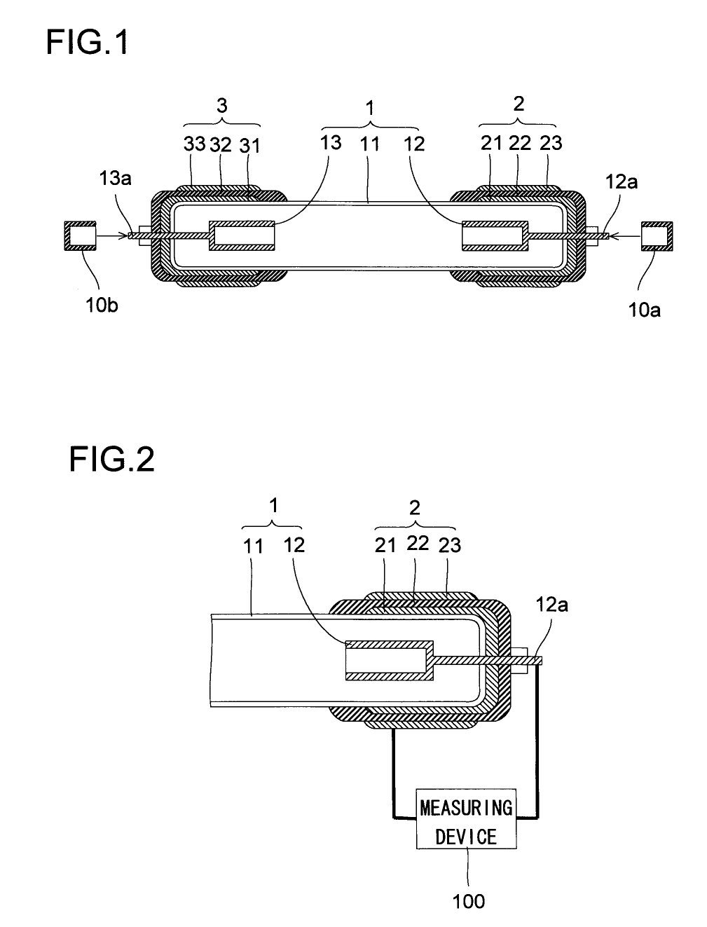

First, with reference to FIGS. 1 to 3, the structure of a cold cathode tube lamp according to a first preferred embodiment of the present invention will be described.

As shown in FIG. 1, the cold cathode tube lamp according to the first preferred embodiment is provided with a discharge tube 1 composed of a hermetic cylindrical glass tube 11 and a pair of internal electrodes 12 and 13 provided inside the glass tube 11. Note that, though not shown, a fluorescent substance is applied on the inner wall surface of the glass tube 11, and rare gas (a mixed gas of Ne and Ar) and mercury vapor are sealed in the glass tube 11. The internal electrodes 12 and 13 are formed of tungsten, and are disposed in one and the other end parts, respectively, of the glass tube 11. Moreover, the internal electrodes 12 and 13 have lead terminal portions 12a and 13a, respectively.

At one and the other end parts of the discharge tube 1, ballast capacitors 2 and 3, respectively are provided integrally therewith. Specifically, the ballast capacitor 2 fitted at the one end part of the discharge tube 1 is composed of a cylindrical inner electrode 21 directly formed on an outer surface of the discharge tube 1 (glass tube 11), a cylindrical dielectric layer 22 so formed as to cover the inner electrode 21, and a cylindrical outer electrode 23 formed on the dielectric layer 22. The ballast capacitor 3 fitted at the other end part of the discharge tube 1 has a structure like that of the ballast capacitor 2 described above, and is composed of a cylindrical inner electrode 31 directly formed on an outer surface of the discharge tube 1 (glass tube 11); a cylindrical dielectric layer 32 so formed as to cover the inner electrode 31; and a cylindrical outer electrode 33 formed on the dielectric layer 32. The inner electrode 21 (31) and the outer electrode 23 (33) are formed of aluminum, and the dielectric layer 22 (32) is formed of yttrium oxide. Note that the inner electrode 21 (31) and the outer electrode 23 (33) are examples of a “first electrode” and a “second electrode,” respectively, according to the present invention.

The lead terminal portion 12a of the internal electrode 12 of the discharge tube 1 penetrates the glass tube 11 and is connected electrically to the inner electrode 21 of the ballast capacitor 2. The lead terminal portion 13a of the internal electrode 13 of the discharge tube 1 penetrates the glass tube 11 and is connected electrically to the inner electrode 31 of the ballast capacitor 3. With this configuration, the internal electrode 12 of the discharge tube 1 and the inner electrode 21 of the ballast capacitor 2 are electrically connected with each other so as to have an equal potential; the internal electrode 13 of the discharge tube 1 and the inner electrode 31 of the ballast capacitor 3 are electrically connected with each other so as to have an equal potential.

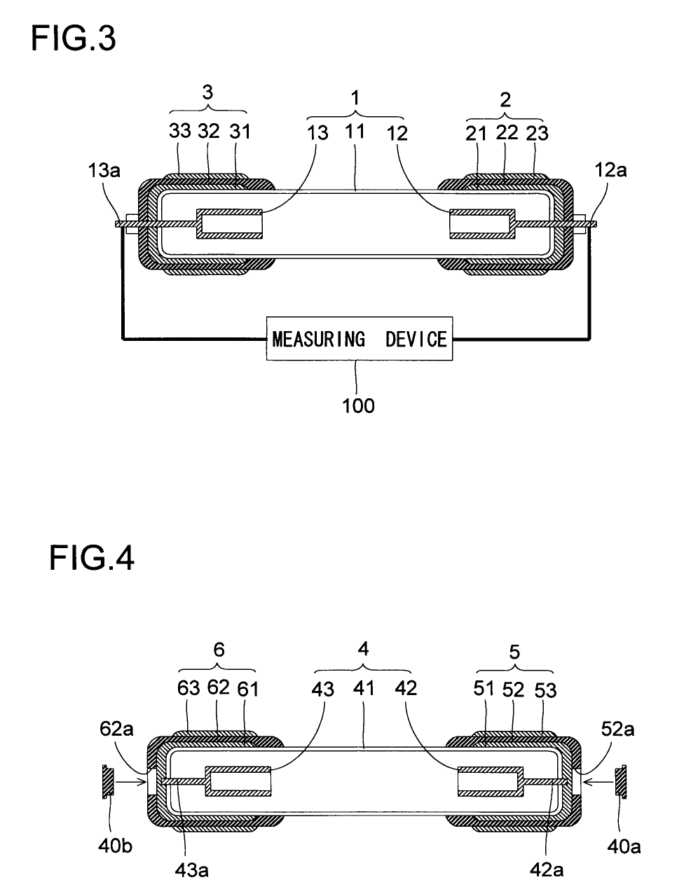

Here, in the first preferred embodiment, the lead terminal portion 12a of the internal electrode 12 located in the one end part of the discharge tube 1 has a part exposed to outside to allow connection to a measuring device 100 (see FIGS. 2 and 3); the lead terminal 13a of the internal electrode 13 located in the other end part of the discharge tube 1 has a part exposed to outside to allow connection to the measuring device 100. Specifically, the lead terminal portion 12a of the internal electrode 12 has a tip part that penetrates the ballast capacitor 2 and projects outward; the lead terminal portion 13a of the internal electrode 13 has a tip part that penetrates the ballast capacitor 3 and projects outward. In other words, in the first preferred embodiment, the tip parts of the lead terminal portion 12a of the internal electrode 12 and the lead terminal portion 13a of the internal electrode 13 are exposed to outside. Moreover, in the first preferred embodiment, insulating caps 10a and 10b are further provided to cover the exposed tip parts of the lead terminal portion 12a of the internal electrode 12 and the lead terminal portion 13a of the internal electrode 13 when no measurement with the measuring device 100 is performed (at the time of shipment, etc).

In the first preferred embodiment, with the configuration described above, it is possible to connect the measuring device 100 to the cold cathode tube lamp in ways shown in FIGS. 2 and 3. Note that the examples of the measuring device 100 include, for example, an LCR meter, and the like.

Specifically, as shown in FIG. 2, it is possible to connect the measuring device 100 to the lead terminal portion 12a of the internal electrode 12 located in the one end part of the discharge tube 1 and to the outer electrode 23 of the ballast capacitor 2. When the measuring device 100 is connected as shown in FIG. 2, since the internal electrode 12 of the discharge tube 1 and the inner electrode 21 of the ballast capacitor 2 have an equal potential, the measuring device 100 is connected to the inner electrode 21 and to the outer electrode 23 of the ballast capacitor 2. As a result, with the measuring device 100, it is possible to measure the capacitance value of the ballast capacitor 2. Note that, although a method of connecting the measuring device 100 at the side of the one end part of the discharge tube 1 alone is shown in FIG. 2, it is possible, also at the side of the other end part of the discharge tube 1, to measure the capacitance value of the ballast capacitor 3 with a similar method.

Moreover, as shown in FIG. 3, it is possible to connect the measuring device 100 to the lead terminal portion 12a of one internal electrode 12 and to the lead terminal portion 13a of the other internal electrode 13 of the discharge tube 1. When the measuring device 100 is connected as shown in FIG. 3, it is possible to measure the electrical characteristics of the discharge tube 1 alone, excluding those of the ballast capacitors 2 and 3.

In the first preferred embodiment, as described above, the ballast capacitor 2 (3) is composed of the inner electrode 21 (31) directly formed on the outer surface of the discharge tube 1, the dielectric layer 22 (32) so formed as to cover the inner electrode 21 (31), and the outer electrode 23 (33) formed on the dielectric layer 22 (32). This makes it possible, without housing the ballast capacitor 2 (3) in a housing member or the like, to fit the ballast capacitor 2 (3) to the discharge tube 1 integrally. In this case, the tip part of the lead terminal portion 12a (13a) of the internal electrode 12 (13) of the discharge tube 1 is exposed to outside to allow connection to the measuring device 100. This makes it possible, since the internal electrode 12 (13) of the discharge tube 1 and the inner electrode 21 (31) of the ballast capacitor 2 (3) are electrically connected with each other so as to have an equal potential, to measure the capacitance value of the ballast capacitor 2 (3) by connecting the measuring device 100 to the internal electrode 12 (13) of the discharge tube 1 and to the outer electrode 23 (33) of the ballast capacitor 2 (3). In this way, it is possible to accurately grasp variations in the capacitance value of the ballast capacitor 2 (3). As a result, in the cold cathode tube lamp that has the ballast capacitor 2 (3) fitted to the discharge tube 1, it is possible to prevent an inconvenience in which, due to the variations in the capacitance value of the ballast capacitor 2 (3), the brightness of the cold cathode tube lamp varies.

Moreover, in the first preferred embodiment, by exposing to outside the tip part of the lead terminal portion 12a (13a) of the internal electrode 12 (13) of the discharge tube 1 as described above, it is possible to expose to outside at least part of the internal electrode 12 (13) of the discharge tube 1 easily.

Moreover, in the first preferred embodiment, by forming the lead terminal portion 12a (13a) of the internal electrode 12 (13) of the discharge tube 1 to have the tip part that penetrates the ballast capacitor 2 (3) and projects outward, it is possible, while electrically connecting the lead terminal portion 12a (13a) of the internal electrode 12 (13) of the discharge tube 1 to the inner electrode 21 (31) of the ballast capacitor 2 (3), to expose to outside the tip part of the lead terminal portion 12a (13a) easily.

Moreover, in the first preferred embodiment, the insulating caps 10a and 10b are provided as described above. Thus, it is possible to insulate the exposed tip part of the lead terminal portion 12a (13a) of the internal electrode 12 (13) of the discharge tube 1 when no measurement with the measuring device 100 is performed (at the time of shipment, etc).

### Second Preferred Embodiment

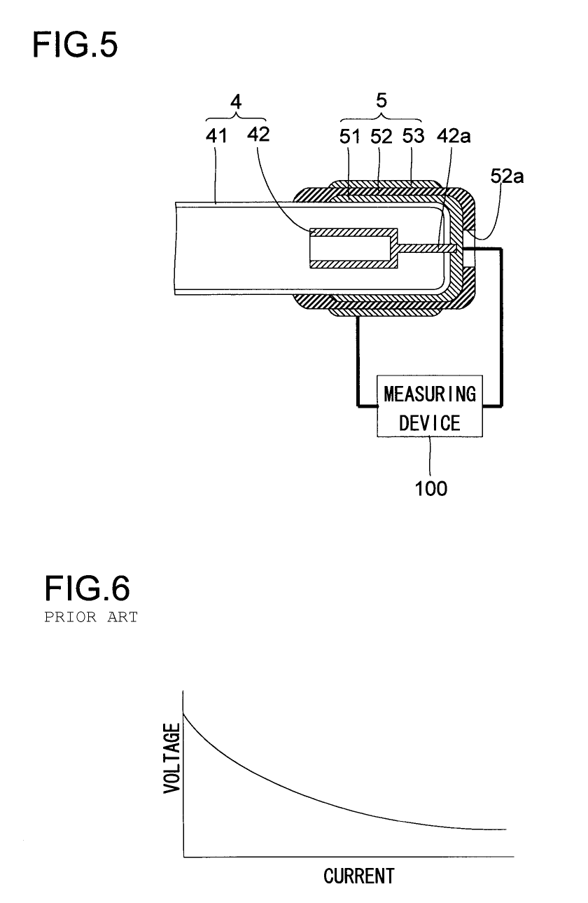

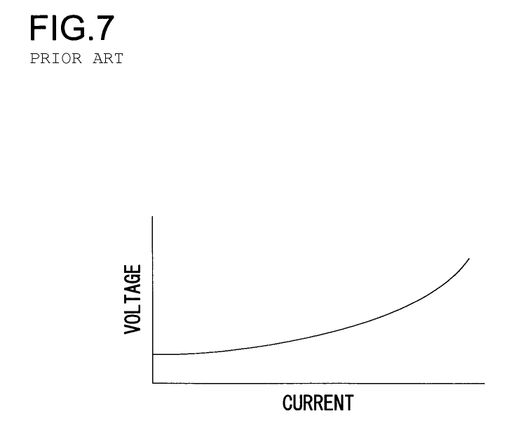

Next, with reference to FIGS. 4 and 5, the structure of a cold cathode tube lamp according to a second preferred embodiment of the present invention will be described.

As shown in FIG. 4, a discharge tube 4 of the cold cathode tube lamp according to the second preferred embodiment has a structure like that of the discharge tube 1 according to the above-described first preferred embodiment, and is composed of a hermetic cylindrical glass tube 41 and a pair of internal electrodes 42 and 43 provided inside the glass tube 41. The internal electrodes 42 and 43 have lead terminal portions 42a and 43a, respectively.

At one and the other end parts of the discharge tube 4, ballast capacitors 5 and 6, respectively are provided integrally therewith. Specifically, the ballast capacitor 5 fitted at the one end part of the discharge tube 4 has a structure like that of the ballast capacitor 2 according to the above-described first preferred embodiment, and is composed of a cylindrical inner electrode 51 directly formed on an outer surface of the discharge tube 4 (glass tube 41), a cylindrical dielectric layer 52 so formed as to cover the inner electrode 51, and a cylindrical outer electrode 53 formed on the dielectric layer 52. The ballast capacitor 6 fitted at the other end part of the discharge tube 4 has a structure like that of the ballast capacitor 3 according to the above-described first preferred embodiment, and is composed of a cylindrical inner electrode 61 directly formed on an outer surface of the discharge tube 4 (glass tube 41), a cylindrical dielectric layer 62 so formed as to cover the inner electrode 61, and a cylindrical outer electrode 63 formed on the dielectric layer 62. Note that the inner electrode 51 (61) and the outer electrode 53 (63) are examples of a “first electrode” and a “second electrode,” respectively, according to the present invention.

The lead terminal portion 42a of the internal electrode 42 of the discharge tube 4 penetrates the glass tube 41 and is connected electrically to the inner electrode 51 of the ballast capacitor 5. The lead terminal portion 43a of the internal electrode 43 of the discharge tube 4 penetrates the glass tube 41 and is connected electrically to the inner electrode 61 of the ballast capacitor 6. With this configuration, the internal electrode 42 of the discharge tube 4 and the inner electrode 51 of the ballast capacitor 5 are electrically connected with each other so as to have an equal potential; the internal electrode 43 of the discharge tube 4 and the inner electrode 61 of the ballast capacitor 6 are electrically connected with each other so as to have an equal potential. Note that in the second preferred embodiment, as distinct from in the above-described first preferred embodiment, the lead terminal portions 42a (43a) of the internal electrode 42 (43) of the discharge tube 4 are formed such that the tip parts thereof do not project outward.

Here, in the second preferred embodiment, the inner electrode 51 of the ballast capacitor 5 fitted at the one end part of the discharge tube 4 has a part exposed to outside to allow connection to a measuring device 100 (see FIG. 5); the inner electrode 61 of the ballast capacitor 6 fitted at the other end part of the discharge tube 4 has a part exposed to outside to allow connection to the measuring device 100. Specifically, in the ballast capacitor 5, an open part 52a is formed in a predetermined region in the dielectric layer 52 that covers the inner electrode 51; through the open part 52a of the dielectric layer 52, part of the inner electrode 51 is exposed to outside. In the ballast capacitor 6, an open part 62a is formed in a predetermined region in the dielectric layer 62 that covers the inner electrode 61; through the open part 62a of the dielectric layer 62, part of the inner electrode 61 is exposed to outside. Moreover, in the second preferred embodiment, insulating caps 40a and 40b are further provided to cover the exposed parts (the open parts 52a and 62a of the dielectric layers 52 and 62) of the inner electrode 51 of the ballast capacitor 5 and the inner electrode 61 of the ballast capacitor 6 when no measurement with the measuring device 100 is performed (at the time of shipment, etc).

In the second preferred embodiment, with the configuration described above, it is possible to connect the measuring device 100 to the cold cathode tube lamp in a way shown in FIG. 5.

Specifically, as shown in FIG. 5, it is possible to connect the measuring device 100 to the inner electrode 51 and to the outer electrode 53 of the ballast capacitor 5 fitted at the one end part of the discharge tube 4. Connecting the measuring device 100 as shown in FIG. 5 makes it possible to measure the capacitance value of the ballast capacitor 5 with the measuring device 100. Note that, although a method of connecting the measuring device 100 at the side of the one end part of the discharge tube 4 alone is shown in FIG. 5, it is possible, also at the side of the other end part of the discharge tube 4, to measure the capacitance value of the ballast capacitor 6 with a similar method.

In the second preferred embodiment, as described above, the ballast capacitor 5 (6) is composed of the inner electrode 51 (61) directly formed on the outer surface of the discharge tube 4, the dielectric layer 52 (62) so formed as to cover the inner electrode 51 (61), and the outer electrode 53 (63) formed on the dielectric layer 52 (62). This makes it possible, as in the above-described first preferred embodiment, without housing the ballast capacitor 5 (6) in a housing member or the like, to fit the ballast capacitor 5 (6) to the discharge tube 4 integrally. In this case, the inner electrode 51 (61) of the ballast capacitor 5 (6) is exposed to outside to allow connection to the measuring device 100. This makes it possible to connect the measuring device 100 to the inner electrode 51 (61) and to the outer electrode 53 (63) of the ballast capacitor 5 (6) and thus to measure the capacitance value of the ballast capacitor 5 (6). In this way, it is possible to accurately grasp variations in the capacitance value of the ballast capacitor 5 (6). As a result, in the cold cathode tube lamp that has the ballast capacitor 5 (6) fitted to the discharge tube 4, it is possible to prevent an inconvenience in which, due to the variations in the capacitance value of the ballast capacitor 5 (6), the brightness of the cold cathode tube lamp varies.

Moreover, in the second preferred embodiment, the open part 52a (62a) to expose part of the inner electrode 51 (61) is formed in a predetermined region in the dielectric layer 52 (62) that covers the inner electrode 51 (61) of the ballast capacitor 5 (6) as described above. This makes it possible to easily expose to outside at least part of the inner electrode 51 (61) of the ballast capacitor 5 (6) through the open part 52a (62a) formed in the dielectric layer 52 (62) of the ballast capacitor 5 (6).

Moreover, in the second preferred embodiment, the insulating caps 40a and 40b are provided as described above. Thus, it is possible to insulate the exposed part of the inner electrode 51 (61) of the ballast capacitor 5 (6) when no measurement with the measuring device 100 is performed (at the time of shipment, etc).

It is to be understood that the preferred embodiments described above are in all aspects simply exemplary and not limitative. The scope of the present invention is set out in the appended claims and not in the description of the preferred embodiments hereinabove, and includes any variations and modifications within the sense and scope equivalent to those of the claims.

For example, although the above-described first and second preferred embodiments deal with the cold cathode tube lamp that has the ballast capacitors fitted to the one and the other end of the discharge tube, respectively, this is not meant to limit the invention; it is also possible to apply the present invention to a cold cathode tube lamp that has a ballast capacitor fitted to either one or the other end part alone of the discharge tube.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-5. (canceled)

6. A cold cathode tube lamp comprising:
a discharge tube having an internal electrode; and
a ballast capacitor fitted integrally with the discharge tube,
wherein
the ballast capacitor is composed of a first electrode directly formed on an outer surface of the discharge tube, a dielectric layer so formed as to cover the first electrode, and a second electrode formed on the dielectric layer,
the internal electrode of the discharge tube and the first electrode of the ballast capacitor are electrically connected with each other so as to have an equal potential, and
at least one of the internal electrode of the discharge tube and the first electrode of the ballast capacitor has a part thereof exposed to outside to allow connection to a measuring device.

7. The cold cathode tube lamp according to claim 6,
wherein
the internal electrode of the discharge tube has a lead terminal portion electrically connected to the first electrode of the ballast capacitor, and
at least part of the lead terminal portion of the internal electrode of the discharge tube is exposed to outside.

8. The cold cathode tube lamp according to claim 7,
wherein at least part of the lead terminal portion of the internal electrode of the discharge tube penetrates the ballast capacitor and projects outward.

9. The cold cathode tube lamp according to claim 6,
wherein in the dielectric layer of the ballast capacitor, an open part is formed to expose to outside at least part of the first electrode of the ballast capacitor.

10. The cold cathode tube lamp according to claim 6, further comprising,
an insulating cap for covering an exposed-to-outside part of at least one of the internal electrode of the discharge tube and the first electrode of the ballast capacitor.
